(19) United States
(12) Patent Application Publication
(10) Pub. No.: US 2005/0017413 A1
(43) Pub. Date: Jan. 27, 2005

(54) Method and apparatus for heating/treating of surfaces which are being molded and assembled

(76) Inventors: Jes Tougaard Gram, Birkerod (DK); Ib Johansen, Vaerlose (DK)

Correspondence Address: LADAS & PARRY LLP, 224 SOUTH MICHIGAN AVENUE, SUITE 1200, CHICAGO, IL, 60604, US

(21) Appl. No.: 10/498,738

(22) PCT Filed: Dec. 17, 2002
(86) PCT No.: PCT/DK02/00867

(30) Foreign Application Priority Data
Dec. 17, 2001 (DK) PA200101889

(51) Int. Cl. B29C 65/00

(52) U.S. Cl. 264/482; 156/60

(57) ABSTRACT

Procedure and mechanism for the treatment, especially through heating of surfaces (8) on plastic objects, which are to be assembled/molded together, and which immediate before are molded or placed in the same special mold, which is equipped with at least one turnable mold part (1). This addition of heat/energy suitably takes place in the form of laser beams (9) or another corresponding precision radiation, that is directed towards at least one of the previous molded border surfaces (8), immediate before the following material is added/molded on. The surfaces (8) can hereby also by the treatment be deformed in chosen areas, which further can increase the adhesion. The invention further implies that you can achieve areas with respectively a good and a bad, or more correct no adhesion, which can be suitable at the production of certain objects.

The invention concerns a procedure and a mechanism for the heating and/or the treatment of surfaces for the assembling/molding together as described in the introduction of claim 1.

From the international PCT-application, PCT/DK 01/00699 is known a method for the assembling of hollow items preferably of plastic, e.g. two ball shells in an apparatus with at least one turnable mold part, and where the assembling takes place in immediate connection with the hollow objects are being molded. From this patent application is it also known that there can be applied heath on those sides of the objects, which are to be brought into contact with each other during the assembling. But it is in this PCT application not further specified how this heat supply is realized. However there have in reality appeared considerable disadvantages by attempts to assemble several combinations of materials, e.g. both uniform, such as polyolefin's, but especially of materials quite different in chemical respect, e.g. polyethylene and polystyrene, as the assembly not has become sufficiently durable, regardless that there is used considerable heat transfer. Besides, it has shown that this heat transfer often at the same time can have that serious disadvantage, that the heat also very easily is risking to deform both the areas, that are to be assembled, and the surrounding areas.

The procedure and the mechanism according to the invention has the purpose to help to eliminate these disadvantages, without at the same time losing the considerable advantage that you according to the above-mentioned patent application achieve by assembling two just molded/together molded objects in the same apparatus, both when it concerns uniform and in chemical respect quite different materials.

This can suitable be achieved by the necessary applying of heat/energy takes place in the form of a guided laser beam from a suitable type of laser or another kind of concentrated radiation. With such a radiation you achieve a combination of advantages, as the laser beam can be programmed to only to influence an exactly specified and specific part of the areas, which are to be assembled, whereby the other part of the surface, its outer contours and further appearance is kept intact. Additionally you can achieve, that the laser beam in the limited areas, where it is destined to hit, can create scratches or other kinds of grooves and/or cuts in the surfaces to be assembled, which makes this assembling easier and more durable because of the hereby achieved supplementing mechanical adhesion.

The procedure and mechanism according to the invention is characterized by the in the characterizing part of claim 1 described.

The at the invention mentioned achieved advantages and the further advantages of the procedure and mechanism according to the invention will appear from the drawing and the description hereof, as

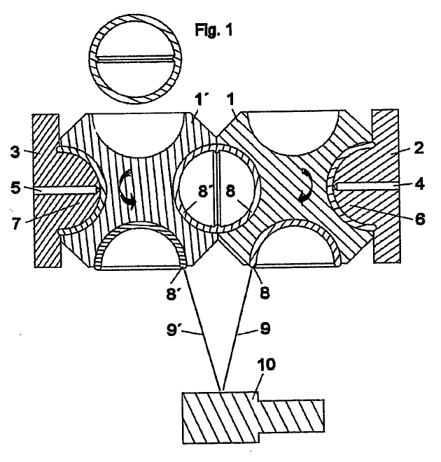

FIG. 1 shows a mechanism according to the invention with two turnable mold parts seen from above in closed condition,

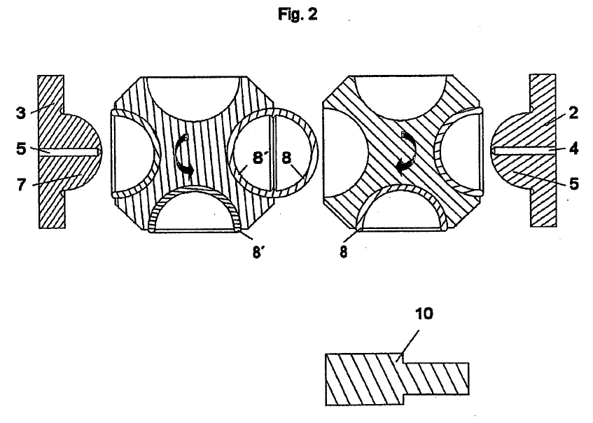

FIG. 2 the same mechanism as in FIG. 1 in open condition,

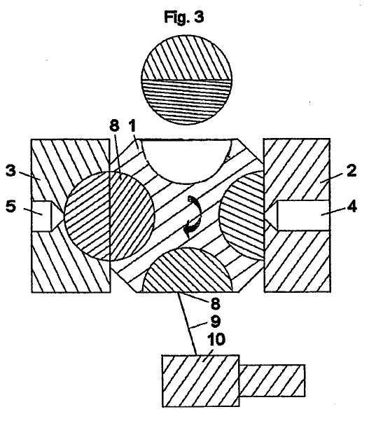

FIG. 3 another mechanism according to the invention with a turnable mold part seen from above in closed condition,

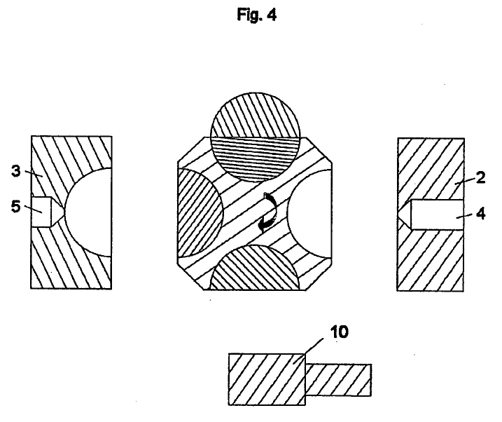

FIG. 4 the same mechanism as in FIG. 3 in open condition.

On FIG. 1 is seen from above shown two turnable mold parts 1 and 1′, which can be turned opposite to each other in the direction of the arrows. The turnable mold parts are shown in closed condition between the stationary mold part 2 and the movable mold part 3. The injection of the plastic material takes place respectively through the channel 4 in the stationary mold part 2 and the channel 5 in the movable mold part 3, and respectively through the core 6 and the core 7. The objects that are molded in each of the turnable mold parts 1 and 1′ are on the figure shown as half ball shells, which are to be put together into a complete hollow ball.

After the cooling, the opening of the mold and respectively the turning of the mold a quarter of a round (90 degrees) in the direction of the arrow, plus the closing of the mold, the two now molded ball-shells will be in the lowest position on the figure. Here their outer surfaces 8 and 8′ win be influenced of the beams 9 and 9′ from the laser 10. After another opening of the mold, 90 degrees turning of the mold in the direction of the arrows and closing of the mold, the radiated surfaces 8 and 8′ are lead together and now adhere into a full, hollow ball. After renewed opening of the mold, turning of the turnable mold parts 1 and 1′ another 90 degrees in the direction of the respective arrows plus ejection of the assembled ball from the mold, the mold is ready for a new cycle as the above-mentioned.

FIG. 2 shows the same mold according to the invention as in FIG. 1, but here in its various opened conditions. The beams from the laser 10 are here shown disrupted, both when the mold is during opening and closing, as the surfaces 8 and 8′ at best are radiated sufficiently precise when the mold is closed and in complete rest.

In FIG. 3 are seen a mechanism according to the invention with only one turnable mold part 1 in closed condition between the stationary mold part 2 and the movable mold part 3, in which there are channels 4 and 5, where through there are added plastic material to the mold on two opposite situated places at the same time. After cooling of the material, opening of the mold, turning of the turnable mold part 90 degrees in the direction of the arrows and re-closing of the mold, it is now the molded (half) object in the lowest position on the figure, where it on the surface 8 is radiated of the beam 9 from the laser 10. After renewed opening of the mold, tuning 90 degrees in the direction of the arrow, and closing of the mold, there now through the channel 5 is molded new material into the mold cavity in the movable mold part 3, which adheres on the radiation treated surface 8 of the already molded (halt) object. After cooling, opening of the mold, renewed turning of 90 degrees, the now assembled object and finished object in its uppermost position on the figure ready for be ejected from the mold, and a new cycle of the same kind is ready to be started.

FIG. 4 shows the same mold as in FIG. 3, but here shown in all its various open positions.

There could on the drawing have been shown more examples of the mechanism according to the invention; but the on the figures shown should be sufficient to show the fundamental principles in the invention. If it had not been drawing-technical very difficult, there could have been shown examples of multi-component objects, where the molding together often is especially problematic, either because of difficult controllable cooling of the first molded object because of its geometry, differences in material thickness and/or the combination of materials with bad mutual adhesion. Here a reheating on selected and precisely limited areas on surfaces, there are to be assembled, exactly by means of a such a precise instrument as a laser or a similar source of energy, will show itself to be a crucial improvement in relation to the hitherto known, and often simply making moldings together possible, which not earlier were possible in an acceptable quality.

1. Procedure and mechanism for the heating/treatment of surfaces (8) for the assembling/molding together preferably of plastic objects, which immediate before are molded or placed into the same mechanism, which is furnished with at least one turnable mold part (1), by the supply of heat on those surfaces (8), which are to be assembled, characterized by the fact, that the supply of heat/energy takes place in the shape of one or more laser beams (9) or another kind of precision-heating, which is directed against at least one of the earlier molded mutual border surfaces (8) immediate before the completion of the object.

2. Procedure and mechanism as mentioned in claim 1, characterized by the fact, that you by means of laser beams (9) or another kind of precision-heating reheats chosen areas of the surface (8) immediate before you mold the following material on.

3. Procedure and mechanism as in at least one of the other claims mentioned, characterized by the fact, that you through the influence according to the invention also deforms the previous molded in chosen areas to such an extent, that you can achieve an improved degree of mechanical bonding with the following material, when this is molded on afterwards.

4. Procedure and mechanism as in at least one of the other claims mentioned, characterized by the fact, that you use a laser (10) or a corresponding equipment to engrave e.g. a pattern or a flow channel, in which the following molding of material can flow and achieve an adhesion even in areas, where the following material normally not would be in possession of sufficient heat/energy to create a sufficiently good chemical/mechanical connection with the first molded.

5. Procedure and mechanism as in at least one of the other claims mentioned, characterized by the fact, that you treat a well defined area of the previous molded objects intended border surface (8) to the following molding, such as that you in this region can achieve a good adhesion on the other material, when this is molded on, at the same time as you can use the failing adhesion in another region e.g. to the creation of a hinge.

6. Procedure and mechanism as in at least one of the other claims mentioned, characterized by the fact, that there is used a combination with a directed heating and a deformation of parts of the two materials mutual border surface (8) and (8′) before the other material is put on/molded on.

7. Procedure and mechanism as in at least one of the other claims mentioned, characterized by the fact, that you add to the object holes, cuts or the corresponding removal of material, which e.g. can result in a better mechanical adhesion or can be used as a decoration.

8. Procedure and mechanism as in at least one of the other claims mentioned, characterized by the fact, that you add heat/energy upon the whole welding area by dividing and guide the laser beam through fiber optics, so that you do not need to change the position itself of the optic/laser (10) during the process, as all the defined welding area is effected at the same time.

9. Procedure and mechanism as in at least one of the other claims mentioned, characterized by the fact, that you put on/add to the welding area an accelerator/catalyst/reflector and/or an absorber, which results in the welding being more effective.

10. Procedure and mechanism as in at least one of the other claims mentioned, characterized by the fact, that the cavities of the mold are used as a reflector at the welding process.
